(19) United States
(12) Patent Application Publication
(10) Pub. No.: US 2026/0352334 A1
(43) Pub. Date: Nov. 5, 2026

(54) ANALOG ROF SYSTEM, MASTER STATION DEVICE, SLAVE STATION DEVICE, AND OPTICAL COMMUNICATION METHOD

(71) Applicants: Sumitomo Electric Industries, Ltd., Osaka-shi, Osaka (JP); NTT, INC., Tokyo (JP)

(72) Inventors: Yusuke MIYAZEKI, Osaka-shi, Osaka (JP); Tomoyuki FUNADA, Osaka-shi, Osaka (JP); Keisuke JINEN, Osaka-shi, Osaka (JP); Isao KATSURA, Osaka-shi, Osaka (JP); Daisuke KAWASE, Osaka-shi, Osaka (JP); Takuto ARAI, Tokyo (JP); Yushi SHIRATO, Tokyo (JP); Kota ITO, Tokyo (JP); Mizuki SUGA, Tokyo (JP); Hideki TOSHINAGA, Tokyo (JP); Daisei UCHIDA, Tokyo (JP); Naoki KITA, Tokyo (JP)

(73) Assignees: Sumitomo Electric Industries, Ltd., Osaka-shi, Osaka (JP); NTT, INC., Tokyo (JP)

(21) Appl. No.: 19/117,980

(22) PCT Filed: Sep. 22, 2023
(86) PCT No.: PCT/JP2023/034505

§ 371 Date: Apr. 3, 2025

(30) Foreign Application Priority Data
Oct. 18, 2022 (JP) 2022-166626

(51) Int. Cl. H04B 10/2575

(52) U.S. Cl. CPC H04B 10/2575

(57) ABSTRACT

An analog RoF system includes a master station device and a slave station device configured to perform transmission and reception of a radio signal through an antenna. The master station device generates control information that is used to control a transmission operation and a reception operation of the radio signal, and transmits an optical signal that includes an analog main signal and a first digital signal including the generated control information, to the slave station device through an optical fiber. The slave station device acquires the control information from the first digital signal included in the optical signal that has been received from the master station device through the optical fiber, and performs a switching process between the transmission operation and the reception operation of the radio signal through the antenna, based on the acquired control information.

### TECHNICAL FIELD

The present disclosure relates to an analog RoF (Radio over Fiber) system, a master station device, a slave station device, and an optical communication method.

This application claims priority on Japanese Patent Application No. 2022-166626 filed on Oct. 18, 2022, the entire content of which is incorporated herein by reference.

### BACKGROUND ART

PATENT LITERATURE 1 (Japanese Laid-Open Patent Publication No. 2016-158062) discloses a communication device as described below. That is, the communication device includes: a packet reception unit that receives a packet storing therein a segmented continuous signal; a signal retention unit that receives and retains a reception continuous signal which is the continuous signal stored in the packet that has been received by the packet reception unit; a transmission timing control unit that, in a case where the packet reception unit has received a packet different from a packet subsequent to the packet received last time, instructs the signal retention unit to output the reception continuous signal at a timing determined based on a time stamp inserted in the header of the packet that has been received this time, and that, in a case where the packet reception unit has received a packet subsequent to the packet received last time, instructs the signal retention unit to output the reception continuous signal at a timing determined in advance based on the size of the segmented continuous signal; and a continuous signal transmission unit that transmits the continuous signal outputted from the signal retention unit to a network for transmission of continuous signals.

In addition, PATENT LITERATURE 2 (Japanese Laid-Open Patent Publication No. 2007-166278) discloses a wireless communication system as described below. That is, the wireless communication system includes a master station device, a slave station device, a network that connects the master station device and the slave station device with each other, and a wireless terminal. The master station device includes: a wireless modulation circuit that modulates data; a wireless demodulation circuit that demodulates data; and a processing unit that packetizes a digital radio signal inputted from the wireless modulation circuit, and transmits the packetized digital radio signal to the network, and that receives a packet from the network, converts the received packet to a digital radio signal, and transfers the digital radio signal to the wireless demodulation circuit. The slave station device includes: a wireless transmission circuit that transmits a radio signal to the wireless terminal; a wireless reception circuit that receives a radio signal from the wireless terminal; and a processing unit that packetizes a digital radio signal inputted from the wireless reception circuit and transmits the packetized digital radio signal to the network, and that receives a packet from the network, extracts a digital radio signal from the received packet, and transfers the extracted digital radio signal to the wireless transmission circuit. The processing units of the master station device and the slave station device synchronize time and clock frequency of the master station device with time and clock frequency of the slave station device, and the processing units add time information to packets that are transmitted in the network, and transmit digital radio signals.

### CITATION LIST

### Patent Literature

PATENT LITERATURE 1: Japanese Laid-Open Patent Publication No. 2016-158062

PATENT LITERATURE 2: Japanese Laid-Open Patent Publication No. 2007-166278

### SUMMARY OF THE INVENTION

### Technical Problem

An analog RoF system according to the present disclosure includes: a master station device; and a slave station device configured to perform transmission and reception of a radio signal through an antenna. The master station device generates control information that is used to control a transmission operation and a reception operation of the radio signal, and transmits an optical signal that includes an analog main signal and a first digital signal including the generated control information, to the slave station device through an optical fiber. The slave station device acquires the control information from the first digital signal included in the optical signal that has been received from the master station device through the optical fiber, and performs a switching process between the transmission operation and the reception operation of the radio signal through the antenna, based on the acquired control information.

A master station device according to the present disclosure includes: a control information generation unit configured to generate control information that is used to control a transmission operation and a reception operation of a radio signal through an antenna to be performed by a slave station device; and a transmission unit configured to transmit an optical signal that includes an analog main signal and a digital signal including the control information that has been generated by the control information generation unit, to the slave station device through an optical fiber.

A slave station device according to the present disclosure includes: a wireless transmission and reception unit configured to perform transmission and reception of a radio signal through an antenna; a reception unit configured to receive an optical signal that includes an analog main signal and a digital signal including control information, from a master station device through an optical fiber; an acquisition unit configured to acquire the control information from the digital signal included in the optical signal that has been received by the reception unit; and a control unit configured to perform a switching process between a transmission operation and a reception operation of the radio signal through the antenna to be performed by the wireless transmission and reception unit, based on the control information acquired by the acquisition unit.

An optical communication method according to the present disclosure is an optical communication method in an analog RoF system including a master station device, and a slave station device configured to perform transmission and reception of a radio signal through an antenna. The optical communication method includes: causing the master station device to generate control information that is used to control a transmission operation and a reception operation of the radio signal, and transmit an optical signal that includes an analog main signal and a first digital signal including the generated control information, to the slave station device through an optical fiber; and causing the slave station device to acquire the control information from the first digital signal included in the optical signal that has been received from the master station device through the optical fiber, and perform a switching process between the transmission operation and the reception operation of the radio signal through the antenna, based on the acquired control information.

One mode of the present disclosure can be realized not only as a master station device including such a characteristic processing unit but also as an optical communication method including such characteristic process steps as well as a program for causing a computer to execute such process steps. Moreover, one mode of the present disclosure can be realized as a semiconductor integrated circuit that realizes a part or the entirety of the master station device.

One mode of the present disclosure can be realized not only as a slave station device including such a characteristic processing unit but also as an optical communication method including such characteristic process steps as well as a program for causing a computer to execute such process steps. Moreover, one mode of the present disclosure can be realized as a semiconductor integrated circuit that realizes a part or the entirety of the slave station device.

### BRIEF DESCRIPTION OF DRAWINGS

FIG. 1 shows a configuration of an analog RoF system according to a first embodiment of the present disclosure.

FIG. 2 shows an example of a time chart of communication frames in a mobile wireless communication system.

FIG. 3 shows a configuration of a master station device according to the first embodiment of the present disclosure.

FIG. 4 shows a configuration of a slave station device according to the first embodiment of the present disclosure.

FIG. 5 shows an example of a TDD signal transmitted by a base station device according to the first embodiment of the present disclosure.

FIG. 6 shows an example of a TDD signal generated by a TDD processing unit in the slave station device according to the first embodiment of the present disclosure.

FIG. 7 shows an example of a sequence of communication in the analog RoF system according to the first embodiment of the present disclosure.

FIG. 8 shows a configuration of an analog RoF system according to a second embodiment of the present disclosure.

FIG. 9 shows a configuration of a master station device according to the second embodiment of the present disclosure.

FIG. 10 shows an example of a correspondence table retained by an information storage unit in the master station device according to the second embodiment of the present disclosure.

FIG. 11 shows a configuration of a slave station device according to the second embodiment of the present disclosure.

FIG. 12 shows a configuration of an analog RoF system according to a third embodiment of the present disclosure.

FIG. 13 shows a configuration of a master station device according to a third embodiment of the present disclosure.

FIG. 14 shows a configuration of a slave station device according to the third embodiment of the present disclosure.

FIG. 15 shows an example of a sequence of communication in the analog RoF system according to the third embodiment of the present disclosure.

### DETAILED DESCRIPTION

Conventionally, a technology for improving communication performance in an optical communication system has been developed.

### Problems to be Solved by the Present Disclosure

A technology capable of realizing TDD (Time Division Duplex) with a simple configuration in an analog RoF system including a master station device and a slave station device is desired, beyond the technologies disclosed in PATENT LITERATURES 1 and 2.

The present disclosure is made to solve the above problem, and an object of the present disclosure is to provide an analog RoF system, a master station device, a slave station device, and an optical communication method that can realize TDD with a simple configuration in the analog RoF system including the master station device and the slave station device.

### Effect of the Present Disclosure

According to the present disclosure, TDD can be realized with a simple configuration in the analog RoF system including the master station device and the slave station device.

### Description of Embodiments of the Present Disclosure

First, the contents of embodiments of the present disclosure will be listed and described.
(1) An analog RoF system according to an embodiment of the present disclosure includes: a master station device; and a slave station device configured to perform transmission and reception of a radio signal through an antenna. The master station device generates control information that is used to control a transmission operation and a reception operation of the radio signal, and transmits an optical signal that includes an analog main signal and a first digital signal including the generated control information, to the slave station device through an optical fiber. The slave station device acquires the control information from the first digital signal included in the optical signal that has been received from the master station device through the optical fiber, and performs a switching process between the transmission operation and the reception operation of the radio signal through the antenna, based on the acquired control information.

With this configuration, the master station device transmits the downlink optical signal that includes the main signal and the first digital signal, to the slave station device through the optical fiber, and the slave station device acquires the control information from the first digital signal included in the downlink optical signal, and performs the switching process between transmission and reception of the radio signal. Thus, the slave station device can perform the switching process between transmission and reception without performing a detailed calculation process or the like for determining a timing of switching between transmission and reception. Therefore, in the analog RoF system including the master station device and the slave station device, TDD can be realized with a simple configuration.
(2) In the above (1), the master station device may be connected between a base station device and the slave station device, and the master station device may receive a pattern signal indicating an uplink communication period and a downlink communication period in TDD from the base station device, and may generate the control information, based on the received pattern signal.

With this configuration, the master station device can generate the control information through a simple process, and the slave station device can perform the switching process between transmission and reception in synchronization with an uplink communication period and a downlink communication period set in the base station device. In addition, in a case where the downlink communication period and the uplink communication period have been changed by the base station device, the control information reflecting the changed content can be transmitted to the slave station device from the master station device, to change the switching process in the slave station device, so that changes in the downlink communication period and the uplink communication period can be flexibly coped with.
(3) In the above (2), the master station device may generate a switching pattern for the transmission operation and the reception operation of the radio signal, based on the pattern signal, and may generate the control information that includes the generated switching pattern and a start timing of the switching process using the switching pattern.

With this configuration, for example, the start timing can be set in consideration of a transmission delay of the control information between the master station device and the slave station device, and the slave station device can stably perform the switching process.
(4) In the above (2), the master station device and the slave station device may each retain correspondence information indicating a correspondence relationship between a type of the pattern signal and identification information of the pattern signal, and the master station device may acquire, with reference to the correspondence information, the identification information corresponding to the pattern signal that has been received from the base station device, and may generate the control information that includes the acquired identification information and the start timing of the switching process using the identification information.

With this configuration, an uplink communication period and a downlink communication period set in the base station device can be notified to the slave station device with a simple configuration, as compared with a configuration in which the control information including the switching pattern for the transmission operation and the reception operation of the radio signal is transmitted to the slave station device from the master station device.
(5) In the above (3) or (4), the analog RoF system may include a plurality of the slave station devices. The master station device may generate the control information including the start timing different for each slave station device.

With this configuration, for example, since the start timing can be set in consideration of a processing delay different for each slave station device, interference between the radio signals transmitted through the antennas by the respective slave station devices can be suppressed.
(6) In any one of the above (3) to (5), the slave station device may correct the start timing included in the control information, and may start the switching process based on the control information at the corrected start timing.

With this configuration, the start timing can be corrected to a more appropriate start timing, based on an actual transmission delay of the control information received in the slave station device, and the like, and the slave station device can stably perform the switching process.
(7) In any one of the above (1) to (6), the slave station device may receive pattern information indicating an uplink communication period and a downlink communication period in TDD from a device, other than the master station device, outside the slave station device, may generate a second digital signal including the received pattern information, and may transmit an optical signal that includes an analog main signal and the generated second digital signal, to the master station device through the optical fiber. The master station device may acquire the pattern information from the second digital signal included in the optical signal that has been received from the slave station device through the optical fiber, and may generate the control information reflecting content of the acquired pattern information.

With this configuration, for example, in a case where a downlink communication period and an uplink communication period in TDD that is employed in a mobile wireless communication system are changed according to the communication state of a mobile communication terminal, changes in the downlink communication period and the uplink communication period can be flexibly coped with.
(8) A master station device according to the embodiment of the present disclosure includes: a control information generation unit configured to generate control information that is used to control a transmission operation and a reception operation of a radio signal through an antenna to be performed by a slave station device; and a transmission unit configured to transmit an optical signal that includes an analog main signal and a digital signal including the control information that has been generated by the control information generation unit, to the slave station device through an optical fiber.

With this configuration, the downlink optical signal that includes the main signal and the digital signal including the control information is transmitted to the slave station device through the optical fiber. Thus, the slave station device can perform the switching process between transmission and reception without performing a detailed calculation process or the like for determining a timing of switching between transmission and reception of the radio signal. Therefore, in the analog RoF system including the master station device and the slave station device, TDD can be realized with a simple configuration.
(9) A slave station device according to the embodiment of the present disclosure includes: a wireless transmission and reception unit configured to perform transmission and reception of a radio signal through an antenna; a reception unit configured to receive an optical signal that includes an analog main signal and a digital signal including control information, from a master station device through an optical fiber; an acquisition unit configured to acquire the control information from the digital signal included in the optical signal that has been received by the reception unit; and a control unit configured to perform a switching process between a transmission operation and a reception operation of the radio signal through the antenna to be performed by the wireless transmission and reception unit, based on the control information acquired by the acquisition unit.

With this configuration, the control information is acquired from the digital signal included in the optical signal, and the switching process between transmission and reception of the radio signal is performed. Thus, it is possible to perform the switching process between transmission and reception without performing a detailed calculation process or the like for determining a timing of switching between transmission and reception of the radio signal. Therefore, in the analog RoF system including the master station device and the slave station device, TDD can be realized with a simple configuration.
(10) A communication method according to the embodiment of the present disclosure is an optical communication method in an analog RoF system including a master station device, and a slave station device configured to perform transmission and reception of a radio signal through an antenna. The communication method includes the steps of: generating, by the master station device, control information that is used to control a transmission operation and a reception operation of the radio signal, and transmitting, by the master station device, an optical signal that includes an analog main signal and a first digital signal including the generated control information, to the slave station device through an optical fiber; and acquiring, by the slave station device, the control information from the first digital signal included in the optical signal that has been received from the master station device through the optical fiber, and performing, by the slave station device, a switching process between the transmission operation and the reception operation of the radio signal through the antenna, based on the acquired control information.

As described above, with the method in which the master station device transmits the downlink optical signal that includes the main signal and the first digital signal, to the slave station device through the optical fiber, and the slave station device acquires the control information from the first digital signal included in the downlink optical signal, and performs the switching process between transmission and reception of the radio signal, the slave station device can perform the switching process between transmission and reception without performing a detailed calculation process or the like for determining a timing of switching between transmission and reception. Therefore, in the analog RoF system including the master station device and the slave station device, TDD can be realized with a simple configuration.

Hereinafter, embodiments of the present disclosure will be described with reference to the drawings. In the drawings, the same or corresponding parts are denoted by the same reference signs, and descriptions thereof are not repeated. At least some parts of the embodiments described below can be combined together as desired.

### First Embodiment

### Configuration and Basic Operation

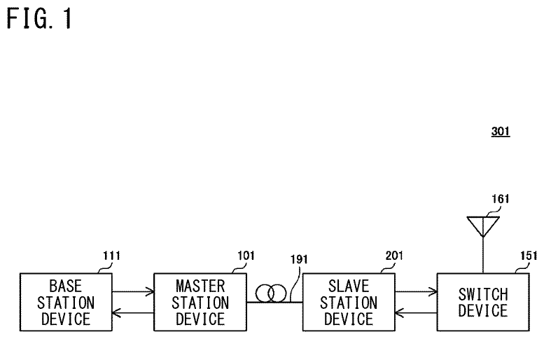

FIG. 1 shows a configuration of an analog RoF system according to a first embodiment of the present disclosure. With reference to FIG. 1, an analog RoF system 301 includes a master station device 101 and a plurality of slave station devices 201. FIG. 1 shows a representative case in which one slave station device 201 is provided. The master station device 101 and the slave station device 201 are connected with each other through an optical fiber 191. The master station device 101 is connected between a base station device 111 and the slave station device 201. The master station device 101 and the plurality of slave station devices 201 may be connected through the optical fiber 191 and an optical coupler. In addition, the analog RoF system 301 may include one slave station device 201.

The master station device 101 and the slave station device 201 perform transmission and reception of an optical signal including communication data that has been generated in the base station device 111, through the optical fiber 191. Hereinafter, an optical signal that is transmitted to the slave station device 201 from the master station device 101 is also referred to as a downlink optical signal, and an optical signal that is transmitted to the master station device 101 from the slave station device 201 is also referred to as an uplink optical signal.

The analog RoF system 301 is used in a mobile wireless communication system that employs TDD. For example, the analog RoF system 301 is used in mobile fronthaul in a 5th-generation mobile communication system (hereinafter, also referred to as 5G) that employs TDD, and a local 5G.

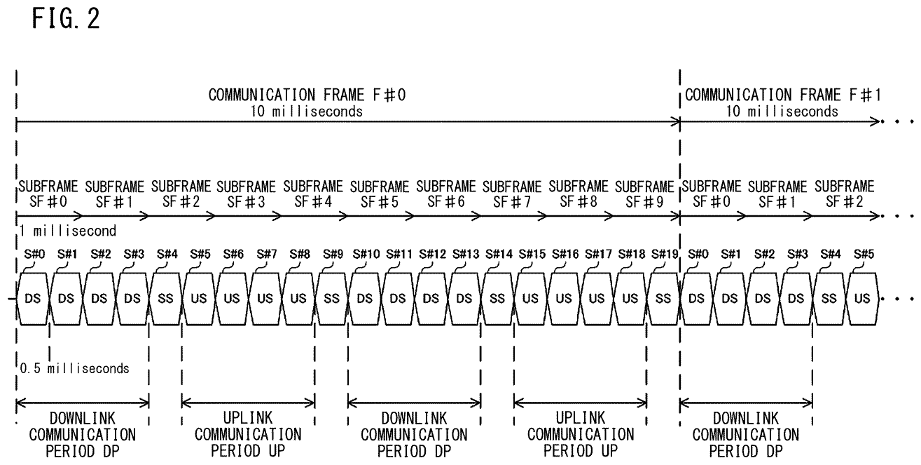

FIG. 2 shows an example of a time chart of communication frames in a mobile wireless communication system. With reference to FIG. 2, a communication frame F including 10 subframes SF #0 to SF #9 is repeated in TDD. Each of the subframes SF includes two time slots S. For example, a period equivalent to one communication frame F is 10 milliseconds, a period equivalent to one subframe SF is 1 millisecond, and a period equivalent to one time slot S is 0.5 milliseconds.

One of an uplink communication slot US for forming an uplink communication period UP in TDD, a downlink communication slot DS for forming a downlink communication period DP in TDD, and a special slot SS which is a switch period between the uplink communication period UP and the downlink communication period DP, is assigned to each time slot S. The uplink communication period UP and the downlink communication period DP are alternately repeated.

In the example shown in FIG. 2, a downlink communication slot DS is assigned to each of time slots S #0, S #1 in subframe SF #0 and time slots S #2, S #3 in subframe SF #1. A special slot SS is assigned to time slot S #4 which is the first time slot S in subframe SF #2. An uplink communication slot US is assigned to each of time slot S #5 which is the second time slot S in subframe SF #2, time slots S #6, S #7 in subframe SF #3, and time slot S #8 which is the first time slot S in subframe SF #4. A special slot SS is assigned to time slot S #9 which is the second time slot S in subframe SF #4. A downlink communication slot DS is assigned to each of time slots S #10, S #11 in subframe SF #5 and time slots S #12, S #13 in subframe SF #6. A special slot SS is assigned to time slot S #14 which is the first time slot S in subframe SF #7. An uplink communication slot US is assigned to each of time slot S #15 which is the second time slot S in subframe SF #7, time slots S #16, S #17 in subframe SF #8, and time slot S #18 which is the first time slot S in subframe SF #9. A special slot SS is assigned to time slot S #19 which is the second time slot S in subframe SF #9.

In the analog RoF system 301, the slave station device 201 transmits communication data to the master station device 101 in an uplink communication period UP, and the master station device 101 transmits communication data to the slave station device 201 in a downlink communication period DP.

More specifically, the master station device 101 receives an OFDM (Orthogonal Frequency Division Multiplexing)-modulated analog signal including communication data, from the base station device 111. The master station device 101 generates an IF (Intermediate Frequency) signal Fa by frequency-converting the received analog signal. The IF signal Fa is an example of a main signal. The master station device 101 transmits a downlink optical signal including the generated IF signal Fa to the slave station device 201 via the optical fiber 191, in the downlink communication period DP.

The slave station device 201 performs transmission and reception of an RF (Radio Frequency) signal through a switch device 151 and an antenna 161. More specifically, the slave station device 201 receives the downlink optical signal from the master station device 101 via the optical fiber 191. Then, the slave station device 201 acquires the IF signal Fa from the received downlink optical signal, and transmits a millimeter-wave-band RF signal based on the acquired IF signal Fa via the switch device 151 and the antenna 161.

In addition, the slave station device 201 receives an OFDM-modulated millimeter-wave-band RF signal including communication data from a mobile communication terminal (not shown) via the antenna 161 and the switch device 151, and generates an IF signal Fb by frequency-converting the received RF signal. The slave station device 201 transmits an uplink optical signal including the generated IF signal Fb to the master station device 101 via the optical fiber 191, in the uplink communication period UP.

The master station device 101 receives the uplink optical signal from the slave station device 201 via the optical fiber 191. The master station device 101 acquires the IF signal Fb from the received uplink optical signal, and transmits a signal based on the acquired IF signal Fb to the base station device 111.

The slave station device 201 transmits a TDD signal Std2 for controlling the state of the switch device 151 to the switch device 151. Based on the TDD signal Std2 received from the slave station device 201, the switch device 151 switches between a transmission state in which the antenna 161 is connected to a transmission circuit for an RF signal in the slave station device 201 and a reception state in which the antenna 161 is connected to a reception circuit for an RF signal in the slave station device 201.

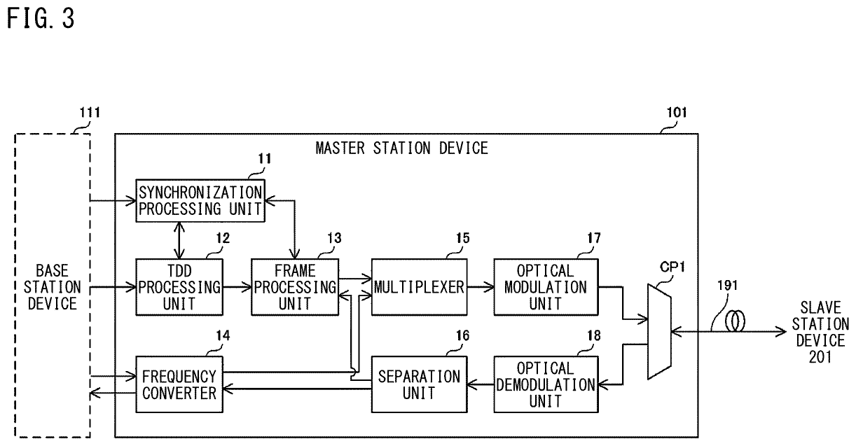

FIG. 3 shows a configuration of the master station device according to the first embodiment of the present disclosure. With reference to FIG. 3, the master station device 101 includes a synchronization processing unit 11, a TDD processing unit 12, a frame processing unit 13, a frequency converter 14, a multiplexer 15, a separation unit 16, an optical modulation unit 17, an optical demodulation unit 18, and an optical coupler CP1. The TDD processing unit 12 is an example of a control information generation unit. The optical modulation unit 17 is an example of a transmission unit.

For example, the synchronization processing unit 11 receives a reference clock from an oscillator outside or inside the master station device 101, and generates a local clock CL1 in which the frequency of the received reference clock is divided or multiplied. The synchronization processing unit 11 performs count-up according to the timing of the generated local clock CL1 and retains the count value. Each unit in the master station device 101 operates based on the local clock CL1.

The synchronization processing unit 11 receives a reference signal from the base station device 111. For example, the synchronization processing unit 11 receives, as the reference signal, a clock signal, a GNSS (Global Navigation Satellite System) signal, or a grandmaster clock signal from the base station device 111. The synchronization processing unit 11 performs a base-station synchronization process of synchronizing the count value of the local clock CL1 with that of the base station device 111, based on the received reference signal. For example, in a case where the wiring between the base station device 111 and the master station device 101 is short, the synchronization processing unit 11 performs the base-station synchronization process, based on the reference signal, without considering a transmission delay of the reference signal between the base station device 111 and the master station device 101.

The frame processing unit 13 generates an Ethernet (registered trademark) frame which is addressed to the slave station device 201 and in which information to be transmitted to the slave station device 201 is stored in the payload. The frame processing unit 13 outputs a digital signal Da including the generated Ethernet frame to the multiplexer 15.

The frequency converter 14 receives an OFDM-modulated analog signal including communication data from the base station device 111. The frequency converter 14 may receive an RF-band analog signal, or may receive a baseband analog signal. The frequency converter 14 generates an IF signal Fa by performing up-conversion or down-conversion on the received analog signal, and outputs the generated IF signal Fa to the multiplexer 15.

The multiplexer 15 frequency-multiplexes the digital signal Da received from the frame processing unit 13 and the IF signal Fa received from the frequency converter 14. The multiplexer 15 generates an electrical signal in which the digital signal Da and the IF signal Fa are frequency-multiplexed, and outputs the electrical signal to the optical modulation unit 17.

The optical modulation unit 17 receives the electrical signal from the multiplexer 15, and generates a downlink optical signal having a wavelength λ1 in which the received electrical signal is optically modulated. The optical modulation unit 17 outputs the downlink optical signal to the optical fiber 191 via the optical coupler CP1 in the downlink communication period DP.

As described above, with a configuration in which the digital signal Da and the IF signal Fa are respectively generated in the units different from each other, and the downlink optical signal including the generated digital signal Da and the generated IF signal Fa is transmitted to the slave station device 201, reduction in the signal quality of the IF signal Fa and a transmission delay of the IF signal Fa can be suppressed.

The master station device 101 may receive the IF signal Fa from the base station device 111, and may transmit the downlink optical signal including the received IF signal Fa to the slave station device 201 via the optical fiber 191. More specifically, the master station device 101 may not necessarily include the frequency converter 14. In this case, the multiplexer 15 receives the IF signal Fa from the base station device 111, and frequency-multiplexes the digital signal Da received from the frame processing unit 13 and the IF signal Fa received from the base station device 111.

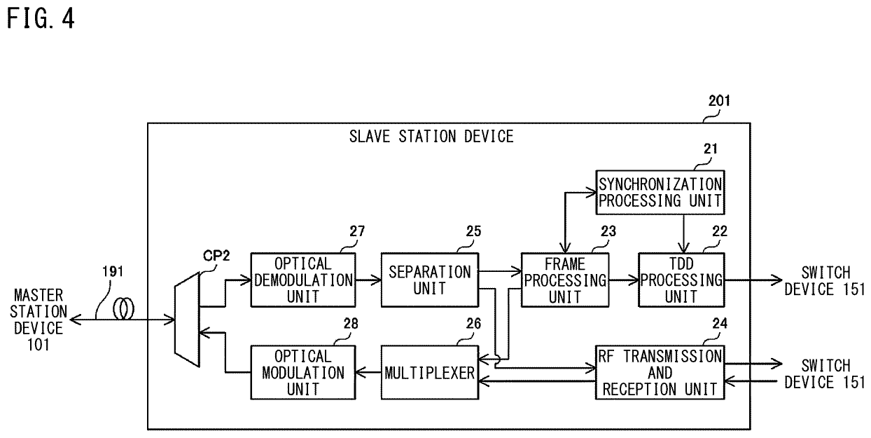

FIG. 4 shows a configuration of the slave station device according to the first embodiment of the present disclosure. With reference to FIG. 4, the slave station device 201 includes a synchronization processing unit 21, a TDD processing unit 22, a frame processing unit 23, an RF transmission and reception unit 24, a separation unit 25, a multiplexer 26, an optical demodulation unit 27, an optical modulation unit 28, and an optical coupler CP2. The RF transmission and reception unit 24 is an example of a wireless transmission and reception unit. The RF transmission and reception unit 24 includes the reception circuit (not shown) that receives an RF signal and the transmission circuit (not shown) that transmits an RF signal. The optical demodulation unit 27 is an example of a reception unit. The frame processing unit 23 is an example of an acquisition unit. The TDD processing unit 22 is an example of a control unit.

For example, the synchronization processing unit 21 receives a reference clock from an oscillator outside or inside the slave station device 201, and generates a local clock CL2 in which the frequency of the received reference clock is divided or multiplied. The synchronization processing unit 21 performs count-up according to the timing of the generated local clock CL2, and retains the count value. Each unit in the slave station device 201 operates based on the local clock CL2. Setting of the frequency of the local clock CL2 is the same as that of the local clock CL1 in the master station device 101.

The optical demodulation unit 27 receives the downlink optical signal from the master station device 101 through the optical fiber 191 and the optical coupler CP2, and generates an electrical signal based on the received downlink optical signal. More specifically, the optical demodulation unit 27 generates the electrical signal having a level corresponding to the intensity of the received downlink optical signal, and outputs the electrical signal to the separation unit 25.

The separation unit 25 receives the electrical signal from the optical demodulation unit 27, separates the IF signal Fa and the digital signal Da included in the received electrical signal from each other, outputs the IF signal Fa to the RF transmission and reception unit 24, and outputs the digital signal Da to the frame processing unit 23. The separation unit 25 is, for example, a diplexer including an HPF (High Pass Filter) and an LPF. The separation unit 25 outputs frequency components having frequencies equal to or higher than a frequency Fx, in the electrical signal received from the optical demodulation unit 27, as the IF signal Fa to the RF transmission and reception unit 24, and outputs frequency components having frequencies lower than the frequency Fx, as the digital signal Da to the frame processing unit 23. Here, the frequency Fx is lower than the center frequency of the IF signal Fa.

For example, the RF transmission and reception unit 24 amplifies the IF signal Fa received from the separation unit 25. The RF transmission and reception unit 24 generates an RF signal by performing up-conversion on the amplified IF signal Fa, and outputs the generated RF signal to the antenna 161 via the switch device 151.

The frame processing unit 23 receives the digital signal Da from the separation unit 25, and acquires the Ethernet frame from the received digital signal Da. In a case where a destination MAC address included in the acquired Ethernet frame does not match the MAC address of the slave station device 201, the frame processing unit 23 discards the Ethernet frame. Meanwhile, in a case where the destination MAC address included in the acquired Ethernet frame matches the MAC address of the slave station device 201, the frame processing unit 23 acquires the information from the payload of the Ethernet frame.

In addition, the frame processing unit 23 generates an Ethernet frame which is addressed to the master station device 101 and in which information to be transmitted to the master station device 101 is stored in the payload. The frame processing unit 23 outputs a digital signal Db including the generated Ethernet frame to the multiplexer 26.

The RF transmission and reception unit 24 receives an OFDM-modulated RF-band analog signal including communication data from a mobile communication terminal (not shown) via the antenna 161 and the switch device 151. The RF transmission and reception unit 24 generates an IF signal Fb by performing down-conversion on the received analog signal, and outputs the generated IF signal Fb to the multiplexer 26.

The multiplexer 26 frequency-multiplexes the digital signal Db received from the frame processing unit 23 and the IF signal Fb received from the RF transmission and reception unit 24. The multiplexer 26 generates an electrical signal in which the digital signal Db and the IF signal Fb are frequency-multiplexed, and outputs the electrical signal to the optical modulation unit 28.

The optical modulation unit 28 transmits an uplink optical signal that includes the digital signal Db and the IF signal Fb, to the master station device 101 through the optical fiber 191. More specifically, the optical modulation unit 28 receives the electrical signal from the multiplexer 26, and generates the uplink optical signal having a wavelength λ2 in which the received electrical signal is optically modulated. The optical modulation unit 28 outputs the uplink optical signal to the optical fiber 191 via the optical coupler CP2 in the uplink communication period UP.

Referring back to FIG. 3, the optical demodulation unit 18 in the master station device 101 receives the uplink optical signal from the slave station device 201 through the optical fiber 191 and the optical coupler CP1, and generates an electrical signal based on the received uplink optical signal. More specifically, the optical demodulation unit 18 generates the electrical signal having a level corresponding to the intensity of the received uplink optical signal, and outputs the electrical signal to the separation unit 16.

The separation unit 16 receives the electrical signal from the optical demodulation unit 18, separates the IF signal Fb and the digital signal Db included in the received electrical signal from each other, outputs the IF signal Fb to the frequency converter 14, and outputs the digital signal Db to the frame processing unit 13. The separation unit 16 is, for example, a diplexer including an HPF and an LPF. The separation unit 16 outputs frequency components having frequencies equal to or higher than a frequency Fy, in the electrical signal received from the optical demodulation unit 18, as the IF signal Fb to the frequency converter 14, and outputs frequency components having frequencies lower than the frequency Fy, as the digital signal Db to the frame processing unit 13. Here, the frequency Fy is lower than the center frequency of the IF signal Fb.

For example, the frequency converter 14 generates an RF signal by performing up-conversion on the IF signal Fb received from the separation unit 16, and transmits the generated RF signal to the base station device 111. Alternatively, the frequency converter 14 generates a baseband signal by performing down-conversion on the IF signal Fb received from the separation unit 16, and transmits the generated baseband signal to the base station device 111. As described above, the master station device 101 may not necessarily include the frequency converter 14. In this case, the separation unit 16 transmits the IF signal Fb to the base station device 111.

The frame processing unit 13 receives the digital signal Db from the separation unit 16, acquires the Ethernet frame from the received digital signal Db, and acquires the information from the payload of the Ethernet frame.

### Inter-Station Synchronization Process

The synchronization processing unit 11 in the master station device 101 and the synchronization processing unit 21 in the slave station device 201 perform an inter-station synchronization process of synchronizing the count value of the local clock CL1 in the master station device 101 with the count value of the local clock CL2 in the slave station device 201, at a synchronization process timing according to a predetermined cycle, for example.

More specifically, in the inter-station synchronization process, the synchronization processing unit 11 acquires the current count value of the local clock CL1, generates count information indicating the acquired count value, and outputs the count information to the frame processing unit 13.

The frame processing unit 13 receives the count information from the synchronization processing unit 11, generates an Ethernet frame which is addressed to the slave station device 201 and in which the received count information is stored in the payload, and outputs a digital signal Da1 including the generated Ethernet frame to the multiplexer 15. The digital signal Da1 outputted to the multiplexer 15 by the frame processing unit 13 is frequency-multiplexed with an IF signal Fa by the multiplexer 15, to be transmitted by the optical modulation unit 17 to the slave station device 201 so as to be included in a downlink optical signal.

Referring back to FIG. 4, the frame processing unit 23 in the slave station device 201 loops back the count information generated in the master station device 101 in the inter-station synchronization process. More specifically, the frame processing unit 23 acquires the Ethernet frame from the digital signal Da1 received from the separation unit 25, and acquires the count information from the payload of the Ethernet frame. The frame processing unit 23 generates an Ethernet frame which is addressed to the master station device 101 and in which the acquired count information is stored in the payload, and outputs a digital signal Db1 including the generated Ethernet frame to the multiplexer 26. The digital signal Db1 outputted to the multiplexer 26 by the frame processing unit 23 is frequency-multiplexed with an IF signal Fb by the multiplexer 26, to be transmitted by the optical modulation unit 28 to the master station device 101 so as to be included in an uplink optical signal.

Referring back to FIG. 3, the frame processing unit 13 in the master station device 101 receives the digital signal Db1 from the separation unit 25, acquires the Ethernet frame from the received digital signal Db1, and acquires the count information from the payload of the Ethernet frame. The frame processing unit 13 outputs the acquired count information to the synchronization processing unit 11.

The synchronization processing unit 11 receives the count information from the frame processing unit 13, and calculates a difference between the count value indicated by the count information and the current count value of the local clock CL1, as an RTT (Round Trip Time) of the count information. In addition, the synchronization processing unit 11 calculates ½ of the RTT, as a transmission delay time DT between the master station device 101 and the slave station device 201.

After calculating the transmission delay time DT, the synchronization processing unit 11 acquires the current count value of the local clock CL1, and generates synchronization information including a synchronization time ST1 obtained by adding the transmission delay time DT to the acquired counter value. The synchronization processing unit 11 outputs the generated synchronization information to the frame processing unit 13.

The frame processing unit 13 receives the synchronization information from the synchronization processing unit 11, generates an Ethernet frame which is addressed to the slave station device 201 and in which the received synchronization information is stored in the payload, and outputs a digital signal Da2 including the generated Ethernet frame to the multiplexer 15. The digital signal Da2 outputted to the multiplexer 15 by the frame processing unit 13 is frequency-multiplexed with an IF signal Fa by the multiplexer 15, to be transmitted by the optical modulation unit 17 to the slave station device 201 so as to be included in a downlink optical signal.

Referring back to FIG. 4, the frame processing unit 23 in the slave station device 201 acquires the Ethernet frame from the digital signal Da2 received from the separation unit 25, and acquires the synchronization information from the payload of the Ethernet frame. The frame processing unit 23 outputs the acquired synchronization information to the synchronization processing unit 21.

The synchronization processing unit 21 receives the synchronization information from the frame processing unit 23, and updates the count value of the local clock CL2, based on the received synchronization information. That is, the synchronization processing unit 21 sets the count value of the local clock CL2 to the synchronization time ST1 included in the synchronization information. Accordingly, the count value of the local clock CL2 in the slave station device 201 is synchronized with the count value of the local clock CL2 in the master station device 101.

The synchronization processing unit 11 in the master station device 101 and the synchronization processing unit 21 in the slave station device 201 may synchronize the count value of the local clock CL1 with the count value of the local clock CL2, according to IEEE 1588.

### Switching Process

Referring back to FIG. 1, the master station device 101 generates control information that is used to control a transmission operation and a reception operation of an RF signal, and transmits a downlink optical signal that includes an IF signal Fa and a digital signal Da3 including the generated control information, to the slave station device 201 through the optical fiber 191.

The slave station device 201 acquires the control information from the digital signal Da3 included in the downlink optical signal that has been received from the master station device 101 through the optical fiber 191, and performs a switching process of switching between the transmission operation and the reception operation of the RF signal through the antenna 161, based on the acquired control information.

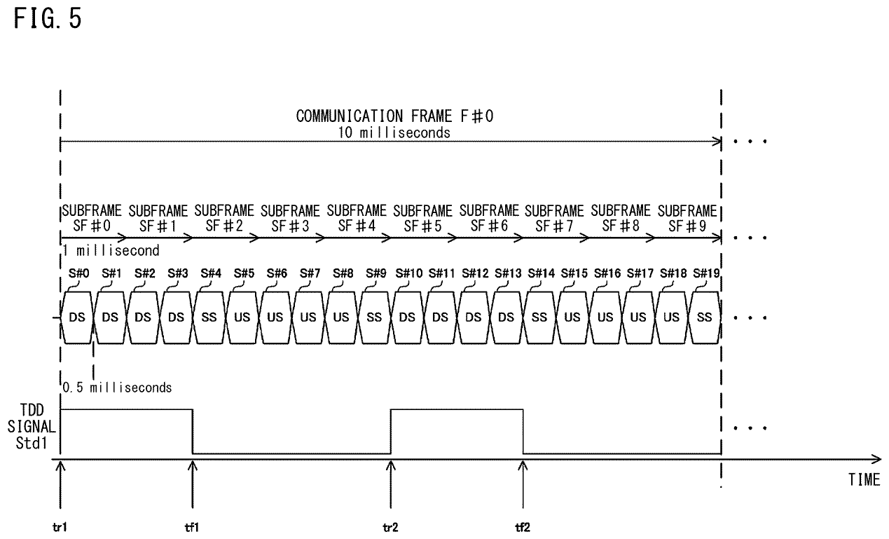

FIG. 5 shows an example of a TDD signal transmitted by the base station device according to the first embodiment of the present disclosure. With reference to FIG. 5, the base station device 111 continuously transmits a rectangular-wave TDD signal Std1 indicating an uplink communication period UP and a downlink communication period DP in TDD, to the master station device 101. The TDD signal Std1 is an example of a pattern signal.

As an example, the TDD signal Std1 is set to a high level in the downlink communication slots DS, and is set to a low level in the uplink communication slots US. For example, the TDD signal Std1 transitions from a high level to a low level at the timing of switching from a downlink communication slot DS to a special slot SS, and transitions from a low level to a high level at the timing of switching from a special slot SS to a downlink communication slot DS.

The TDD processing unit 12 in the master station device 101 receives the TDD signal Std1 from the base station device 111, and generates control information, based on the received TDD signal Std1. As an example, the TDD processing unit 12 generates the control information at a generation timing according to a predetermined generation cycle Cy. For example, the length of the generation cycle Cy is 10 milliseconds which is equivalent to one cycle of the communication frame F. The length of the generation cycle Cy may be equivalent to the length of multiple cycles of the communication frame F.

For example, the TDD processing unit 12 determines a transition time tr as a timing at which the TDD signal Std1 has transitioned from a low level to a high level, and determines a transition time tf as a timing at which the TDD signal Std1 has transitioned from a high level to a low level.

More specifically, when the TDD processing unit 12 has detected that the TDD signal Std1 has transitioned from a low level to a high level, the TDD processing unit 12 acquires the current count value of the local clock CL1 retained by the synchronization processing unit 11, as transition time tr1 which is the first transition time tr. Next, when the TDD processing unit 12 has detected that the TDD signal Std1 has transitioned from a high level to a low level, the TDD processing unit 12 acquires the current count value of the local clock CL1 retained by the synchronization processing unit 11, as transition time tf1 which is the first transition time tf. Next, when the TDD processing unit 12 has detected that the TDD signal Std1 has transitioned from a low level to a high level, the TDD processing unit 12 acquires the current count value of the local clock CL1 retained by the synchronization processing unit 11, as transition time tr2 which is the second transition time tr. Next, when the TDD processing unit 12 has detected that the TDD signal Std1 has transitioned from a high level to a low level, the TDD processing unit 12 acquires the current count value of the local clock CL1 retained by the synchronization processing unit 11, as transition time tf2 which is the second transition time tf. The TDD processing unit 12 may acquire an absolute time as each of transition times tr, tf instead of the count value.

The TDD processing unit 12 generates a switching pattern, which includes transition times tr1, tf1, tr2, tf2 determined for the last 10 milliseconds, for a transmission operation and a reception operation of an RF signal through the antenna 161 to be performed by the slave station device 201.

After generating the switching pattern, the TDD processing unit 12 sets a start timing ts of the switching process using the switching pattern. As an example, the TDD processing unit 12 sets, as the start timing ts, a time obtained by adding a margin time Tm having a predetermined length to transition time tr1 which is the earliest time among transition times tr1, tf1, tr2, tf2. The margin time Tm is, for example, 10 milliseconds which is equivalent to one cycle of the communication frame F.

Referring back to FIG. 3, the TDD processing unit 12 generates the switching pattern and sets the start timing ts, and generates the control information including the generated switching pattern and the start timing ts, at the generation timing according to the generation cycle Cy. For example, the TDD processing unit 12 generates the control information including the start timing ts different for each slave station device 201. More specifically, the TDD processing unit 12 sets the start timing ts to which the margin time Tm having a length different for each slave station device 201 has been added. The TDD processing unit 12 outputs the generated control information to the frame processing unit 13.

The frame processing unit 13 receives the control information from the TDD processing unit 12, generates an Ethernet frame which is addressed to the slave station device 201 and in which the received control information is stored in the payload, and outputs a digital signal Da3 including the generated Ethernet frame to the multiplexer 15.

The multiplexer 15 frequency-multiplexes the digital signal Da3 received from the frame processing unit 13 and an IF signal Fa received from the frequency converter 14. The multiplexer 15 generates an electrical signal in which the digital signal Da3 and the IF signal Fa are frequency-multiplexed, and outputs the electrical signal to the optical modulation unit 17.

The optical modulation unit 17 transmits a downlink optical signal that includes the IF signal Fa and the digital signal Da3, to the slave station device 201 through the optical fiber 191. More specifically, the optical modulation unit 17 receives the electrical signal from the multiplexer 15, and generates the downlink optical signal in which the received electrical signal is optically modulated. The optical modulation unit 17 outputs the downlink optical signal to the optical fiber 191 via the optical coupler CP1 in the downlink communication period DP.

Referring back to FIG. 4, the optical demodulation unit 27 in the slave station device 201 receives the downlink optical signal that includes the IF signal Fa and the digital signal Da3, from the master station device 101 through the optical fiber 191. The optical demodulation unit 27 generates an electrical signal having a level corresponding to the intensity of the received downlink optical signal, and outputs the electrical signal to the separation unit 25.

The separation unit 25 receives the electrical signal from the optical demodulation unit 27, separates the IF signal Fa and the digital signal Da3 included in the received electrical signal from each other, outputs the IF signal Fa to the RF transmission and reception unit 24, and outputs the digital signal Da3 to the frame processing unit 23.

The frame processing unit 23 acquires the control information from the digital signal Da3 included in the downlink optical signal that has been received by the optical modulation unit 17. More specifically, the frame processing unit 23 receives the digital signal Da3 from the separation unit 25, acquires the Ethernet frame from the received digital signal Da3, and acquires the control information from the payload of the Ethernet frame. The frame processing unit 23 outputs the acquired control information to the TDD processing unit 22.

The TDD processing unit 22 performs the switching process between a transmission operation and a reception operation of an RF signal to be performed by the RF transmission and reception unit 24, based on the control information acquired by the frame processing unit 23.

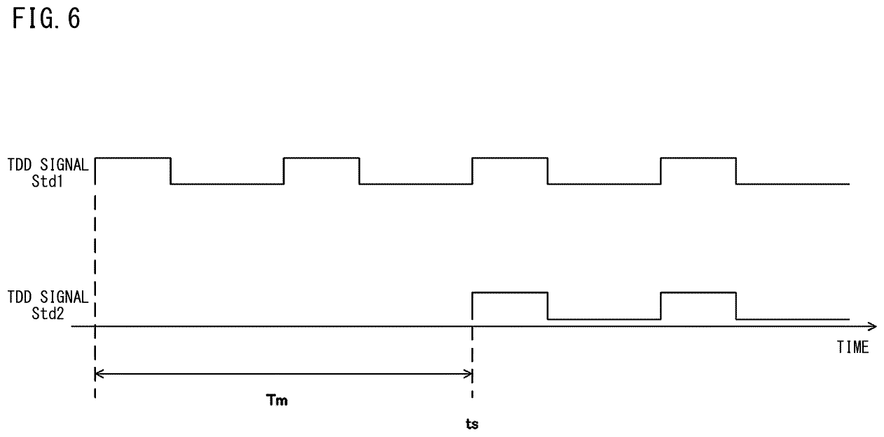

FIG. 6 shows an example of a TDD signal generated by the TDD processing unit in the slave station device according to the first embodiment of the present disclosure. With reference to FIG. 6, the TDD processing unit 22 receives the control information from the frame processing unit 23, generates a TDD signal Std2 based on the switching pattern included in the received control information, and transmits the generated TDD signal Std2 to the switch device 151 at the start timing ts included in the control information.

Here, the length of the optical fiber 191 that connects the master station device 101 and the slave station device 201 with each other is, for example, about 30 km, and a transmission delay may occur between the master station device 101 and the slave station device 201, depending on the length of the optical fiber 191. The master station device 101 sets, as the start timing ts, a time obtained by adding the margin time Tm to transition time tr1, whereby the slave station device 201 can receive the control information before the set start timing ts and can transmit the TDD signal Std2 to the switch device 151 at the start timing ts.

The switch device 151 connects the antenna 161 to the transmission circuit in the RF transmission and reception unit 24 during a high-level period of the TDD signal Std2 received from the slave station device 201, and connects the antenna 161 to the reception circuit in the RF transmission and reception unit 24 during a low-level period of the TDD signal Std2 received from the slave station device 201.

The TDD processing unit 22 may correct the start timing ts included in the control information, and may start the switching process based on the control information at a start timing tsx obtained through correction. More specifically, the TDD processing unit 22 determines the start timing tsx by adding a delay time required for processing of the control information to the start timing ts, and transmits the generated TDD signal Std2 to the switch device 151 at the determined start timing tsx.

### Operation Flow

Each of the devices in the analog RoF system according to the embodiment of the present disclosure includes a computer that includes a memory. An arithmetic processing unit such as a CPU in the computer reads out, from the memory, a program including a part or all of steps in the flowchart and sequence shown below, and executes the program. Programs for the devices can each be installed from outside. The programs for the devices are each distributed in a state of being stored in a recording medium or through a communication line.

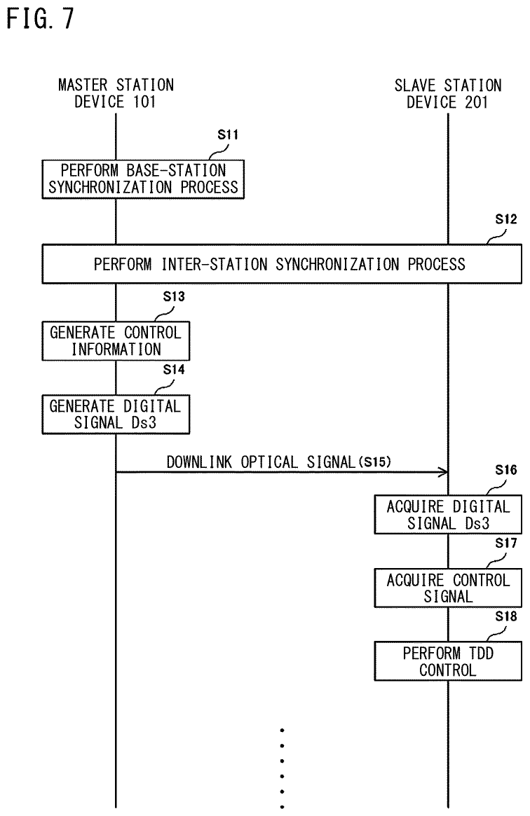

FIG. 7 shows an example of a sequence of communication in the analog RoF system according to the first embodiment of the present disclosure.

With reference to FIG. 7, first, the master station device 101 performs the base-station synchronization process of synchronizing the count value of the local clock CL1 with that of the base station device 111 (step S11).

Next, the master station device 101 and the slave station device 201 perform the inter-station synchronization process of synchronizing the count value of the local clock CL1 in the master station device 101 with the count value of the local clock CL2 in the slave station device 201 at a synchronization process timing according to a predetermined cycle (step S12).

Next, the master station device 101 determines transition times tr1, tr2 each of which is a timing at which the TDD signal Std1 received from the base station device 111 has transitioned from a low level to a high level, determines transition times tf1, tf2 each of which is a timing at which the TDD signal Std1 has transitioned from a high level to a low level, and generates control information that includes a switching pattern including transition times tr1, tf1, tr2, tf2 and a start timing ts (step S13).

Next, the master station device 101 generates an Ethernet frame which is addressed to the slave station device 201 and in which the generated control information is stored in the payload, and generates a digital signal Da3 including the generated Ethernet frame (step S14).

Next, the master station device 101 frequency-multiplexes the digital signal Da3 and the IF signal Fa, and transmits a downlink optical signal that includes the digital signal Da3 and the IF signal Fa, to the slave station device 201 through the optical fiber 191 (step S15).

Next, the slave station device 201 receives the downlink optical signal from the master station device 101 through the optical fiber 191, and acquires the digital signal Ds3 from the received downlink optical signal (step S16).

Next, the slave station device 201 acquires the control information from the digital signal Ds3 (step S17).

Next, the slave station device 201 performs the switching process, based on the acquired control information. More specifically, the slave station device 201 generates a TDD signal Std2, based on the switching pattern included in the control information, and transmits the TDD signal Std2 to the switch device 151 at the start timing ts included in the control information (step S18).

In the analog RoF system 301 according to the first embodiment of the present disclosure, the slave station device 201 performs transmission and reception of an RF signal through the switch device 151 and the antenna 161, but the present invention is not limited thereto. The slave station device 201 may include the switch device 151.

Meanwhile, in the analog RoF system 301 including the master station device 101 and the slave station device 201, a technology capable of realizing TDD with a simple configuration is desired.

For example, in a mobile wireless communication system that employs TDD, it is desired that a transmission timing of an RF signal is controlled with high accuracy in order to suppressing radio-frequency interference.

In addition, for example, the coverage area of the antenna 161 is small in a mobile wireless communication system using the millimeter-wave band, and thus more slave station devices 201 and more antennas 161 need to be installed at high density. Therefore, in order to realize the mobile wireless communication system using the millimeter-wave band at low cost and with a simple configuration, the configuration of the slave station device 201 is desired to be simplified.

On the other hand, in the analog RoF system 301 according to the first embodiment of the present disclosure, the master station device 101 generates control information that is used to control a transmission operation and a reception operation of an RF signal, and transmits a downlink optical signal that includes the IF signal Fa and the digital signal Ds3 including the generated control information, to the slave station device 201 through the optical fiber 191. The slave station device 201 acquires the control information from the digital signal Ds3 included in the downlink optical signal that has been received from the master station device 101 through the optical fiber 191, and performs the switching process between the transmission operation and the reception operation of the RF signal through the antenna 161, based on the acquired control information.

In the above configuration, the master station device 101 transmits the downlink optical signal that includes the IF signal Fa and the digital signal Ds3, to the slave station device 201 through the optical fiber 191, and the slave station device 201 acquires the control information from the digital signal Ds3 included in the downlink optical signal, and performs the switching process between the transmission operation and the reception operation of the RF signal through the antenna 161, based on the acquired control information. Thus, the control information can be transmitted to the slave station device 201 from the master station device 101 through the optical fiber 191, and the switching process between the transmission operation and the reception operation in the slave station device 201 can be performed. Therefore, in the analog RoF system 301 including the master station device 101 and the slave station device 201, TDD can be realized with a simple configuration.

In addition, the content of the switching process between the transmission operation and the reception operation in the slave station device 201 can be changed flexibly by changing the content of the control information that is generated in the master station device 101.

Next, another embodiment of the present disclosure will be described with reference to the drawings. In the drawings, the same or corresponding parts are denoted by the same reference signs, and descriptions thereof are not repeated.

### Second Embodiment

The present embodiment relates to an analog RoF system 302 in which control information further including configuration numbers that each indicate the type of a TDD signal Std1 is transmitted, as compared with the analog RoF system 301 according to the first embodiment. Contents other than those described below are the same as those of the analog RoF system 301 according to the first embodiment.

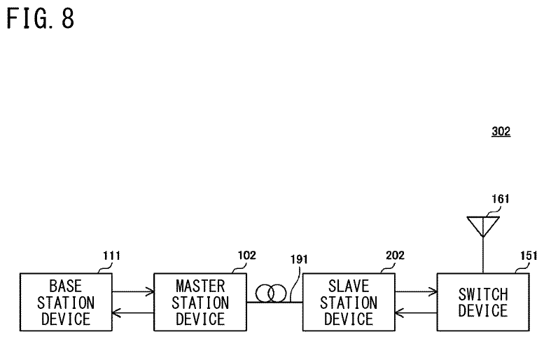

FIG. 8 shows a configuration of the analog RoF system according to a second embodiment of the present disclosure. With reference to FIG. 8, the analog RoF system 302 includes a master station device 102 instead of the master station device 101, and includes a slave station device 202 instead of the slave station device 201, as compared with the analog RoF system 301 shown in FIG. 1.

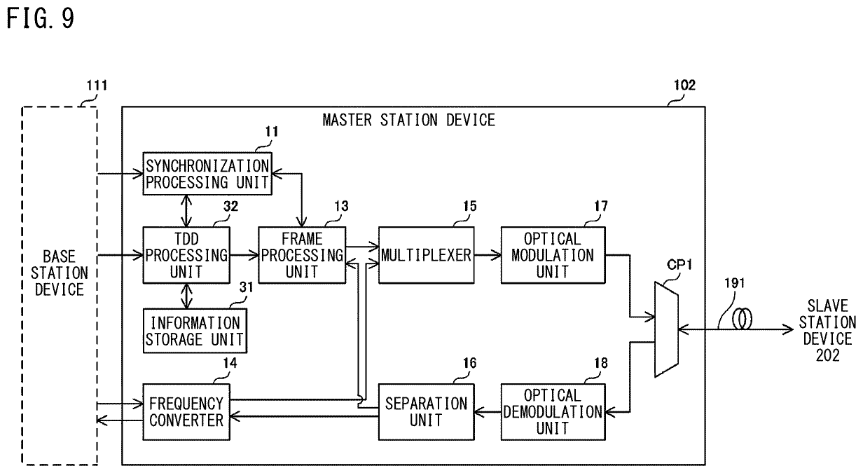

FIG. 9 shows a configuration of the master station device according to the second embodiment of the present disclosure. With reference to FIG. 9, the master station device 102 includes a TDD processing unit 32 instead of the TDD processing unit 12, and further includes an information storage unit 31, as compared with the master station device 101 shown in FIG. 3.

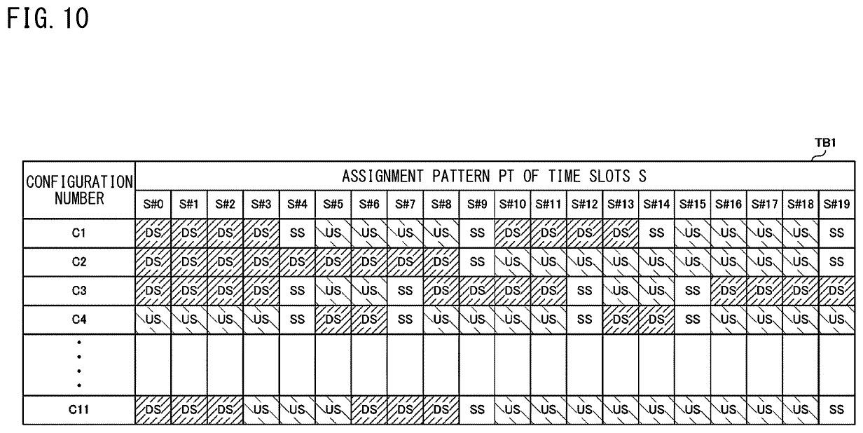

FIG. 10 shows an example of a correspondence table retained by the information storage unit in the master station device according to the second embodiment of the present disclosure. With reference to FIG. 10, the information storage unit 31 retains a correspondence table TB1 indicating the correspondence relationship between an assignment pattern PT of time slots S in a communication frame F and a configuration number which is identification information of the TDD signal Std1. The correspondence table TB1 is an example of correspondence information. The pattern of the time slots S in the communication frame F indicates the type of the TDD signal Std1.

The correspondence table TB1 indicates that a TDD signal Std1 having a configuration number “C1” corresponds to an assignment pattern PT in which a set of four downlink communication slots DS and a set of four uplink communication slots US are alternately repeated, with a special slot SS interposed therebetween. In addition, the correspondence table TB1 indicates that a TDD signal Std1 having a configuration number “C2” corresponds to an assignment pattern PT in which nine downlink communication slots DS and nine uplink communication slots US are alternately repeated, with a special slot SS interposed therebetween. In addition, the correspondence table TB1 indicates that a TDD signal Std1 having a configuration number “C3” corresponds to an assignment pattern PT in which four downlink communication slots DS and two uplink communication slots US are alternately repeated, with a special slot SS interposed therebetween. In addition, the correspondence table TB1 indicates that a TDD signal Std1 having a configuration number “C4” corresponds to an assignment pattern PT in which four uplink communication slots US and two downlink communication slots DS are alternately repeated, with a special slot SS interposed therebetween. In addition, the correspondence table TB1 indicates that a TDD signal Std1 having a configuration number “C11” corresponds to an assignment pattern PT obtained by performing changing such that, in the assignment pattern PT of the TDD signal Std1 having the configuration number “C2”, the downlink communication slots DS are changed to the uplink communication slots US, in the time slots S #3 to S #5.

The correspondence table TB1 retained by the information storage unit 31 may be updated by a control device (not shown). In a case where the correspondence table TB1 in the information storage unit 31 has been updated, the master station device 102 transmits the updated correspondence table TB1 to the slave station device 202.

After acquiring transition times tr, tf of the TDD signal Std1 received from the base station device 111, the TDD processing unit 32 generates a switching pattern including the acquired transition times tr, tf, and sets a start timing ts.

In addition, the TDD processing unit 32 acquires, with reference to the correspondence table TB1 in the information storage unit 31, a configuration number corresponding to the TDD signal Std1 received from the base station device 111. More specifically, the TDD processing unit 32 acquires the configuration number corresponding to the type of the TDD signal Std1 indicated by the acquired transition times tr, tf.

The TDD processing unit 32 generates control information including the switching pattern, the start timing ts, and the acquired configuration number, and outputs the generated control information to the frame processing unit 13.

The frame processing unit 13 receives the control information from the TDD processing unit 32, generates an Ethernet frame which is addressed to the slave station device 201 and in which the received control information is stored in the payload, and outputs a digital signal Da4 including the generated Ethernet frame to the multiplexer 15.

The multiplexer 15 frequency-multiplexes the digital signal Da4 received from the frame processing unit 13 and an IF signal Fa received from the frequency converter 14. The multiplexer 15 generates an electrical signal in which the digital signal Da4 and the IF signal Fa are frequency-multiplexed, and outputs the electrical signal to the optical modulation unit 17.

The optical modulation unit 17 transmits a downlink optical signal that includes the digital signal Da4 and the IF signal Fa, to the slave station device 202 through the optical fiber 191. More specifically, the optical modulation unit 17 receives the electrical signal from the multiplexer 15, and generates the downlink optical signal by light-modulating the received electrical signal. The optical modulation unit 17 outputs the downlink optical signal to the optical fiber 191 via the optical coupler CP1 in the downlink communication period DP.

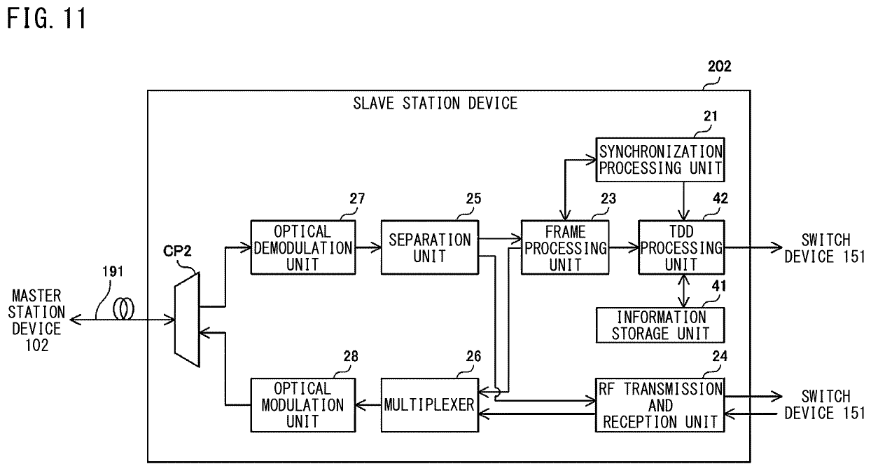

FIG. 11 shows a configuration of the slave station device according to the second embodiment of the present disclosure. With reference to FIG. 11, the slave station device 202 includes a TDD processing unit 42 instead of the TDD processing unit 22, and further includes an information storage unit 41, as compared with the slave station device 201 shown in FIG. 4.

The information storage unit 41 retains the correspondence table TB1, as the information storage unit 31 in the master station device 102.

The optical demodulation unit 27 receives the downlink optical signal that includes the digital signal Da4 and the IF signal Fa, from the master station device 101 through the optical fiber 191, generates an electrical signal having a level corresponding to the intensity of the received downlink optical signal, and outputs the electrical signal to the separation unit 25.

The separation unit 25 receives the electrical signal from the optical demodulation unit 27, separates the IF signal Fa and the digital signal Da4 included in the received electrical signal from each other, outputs the IF signal Fa to the RF transmission and reception unit 24, and outputs the digital signal Da4 to the frame processing unit 23.

The frame processing unit 23 receives the digital signal Da4 from the separation unit 25, acquires the Ethernet frame from the received digital signal Da4, and acquires the control information from the payload of the Ethernet frame. The frame processing unit 23 outputs the acquired control information to the TDD processing unit 42.

The TDD processing unit 42 receives the control information from the frame processing unit 23, and acquires a configuration number from the received control information. The TDD processing unit 42 acquires, with reference to the correspondence table TB1 in the information storage unit 41, an assignment pattern PT corresponding to the acquired configuration number. The TDD processing unit 42 generates a TDD signal Std2 based on the acquired assignment pattern PT, and transmits the generated TDD signal Std2 to the switch device 151 at the start timing ts included in the control information.

The TDD processing unit 42 may correct the start timing ts included in the control information, and may start the switching process based on the control information at a start timing tsx obtained through correction. For example, the TDD processing unit 42 corrects the start timing ts included in the control information that has been received from the frame processing unit 23, based on the acquired assignment pattern PT. More specifically, in a case where the differences between the transition times tr, tf included in the control information and the transition times tr, tf estimated from the acquired assignment pattern PT are equal to or larger than a predetermined value, the TDD processing unit 42 corrects the start timing ts included in the control information such that the differences become smaller.

In addition, for example, the TDD processing unit 42 may perform error correction for the TDD signal Std2 generated based on the switching pattern, based on the acquired assignment pattern PT, or may perform duty cycle distortion correction for the generated TDD signal Std2.

In the analog RoF system 302 according to the second embodiment of the present disclosure, the TDD processing unit 32 in the master station device 102 acquires a configuration number corresponding to the TDD signal Std1 that has been received from the base station device 111, but the present disclosure is not limited thereto. The TDD processing unit 32 may be notified of the configuration number from the base station device 111. In this case, the TDD processing unit 32 generates control information including the notified configuration number, and outputs the control information to the frame processing unit 23. In addition, in this case, the TDD processing unit 32 may not necessarily receive the TDD signal Std1 from the base station device 111.

Next, another embodiment of the present disclosure will be described with reference to the drawings. In the drawings, the same or corresponding parts are denoted by the same reference signs, and descriptions thereof are not repeated.

### Third Embodiment

The present embodiment relates to an analog RoF system 303 in which control information is generated based on pattern information received from a management device 171 in a mobile wireless communication system, as compared with the analog RoF system 302 according to the second embodiment. Contents other than those described below are the same as those of the analog RoF system 302 according to the second embodiment.

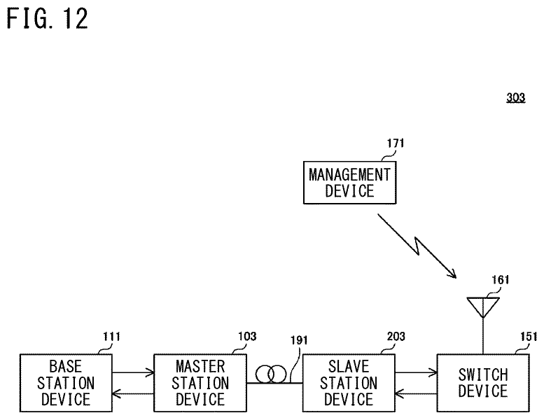

FIG. 12 shows a configuration of the analog RoF system according to a third embodiment of the present disclosure. With reference to FIG. 12, the analog RoF system 303 includes a master station device 103 instead of the master station device 102, and includes a slave station device 203 instead of the slave station device 202, as compared with the analog RoF system 302 shown in FIG. 8.

The slave station device 203 receives pattern information indicating an uplink communication period UP and a downlink communication period DP in TDD from a device, other than the master station device 103, located outside the slave station device 203. For example, the slave station device 203 receives the pattern information from the management device 171 in the mobile wireless communication system.

More specifically, in order to improve the link speed of the uplink communication, according to the communication state or the like of a mobile communication terminal in the mobile wireless communication system, the management device 171, for example, changes a part of the downlink communication period DP to the uplink communication period UP in TDD with respect to some of the slave station devices 203, in some cases. In a case where the management device 171 changes a part of a downlink communication period DP to an uplink communication period UP, the management device 171 generates pattern information including a configuration number corresponding to an assignment pattern PT of time slots S that indicates the changed uplink communication period UP and the changed downlink communication period DP. The management device 171 generates a frame which is addressed to the slave station device 203 and in which the generated pattern information is stored, and transmits an RF signal including the generated frame. In order to improve the link speed of the downlink communication, the management device 171 may change a part of an uplink communication period UP to a downlink communication period DP, and may generate pattern information including a configuration number corresponding to an assignment pattern PT of time slots S that indicates the changed uplink communication period UP and the changed downlink communication period DP. In addition, the management device 171 may transmit the frame including the pattern information to the slave station device 203 via a wired transmission line.

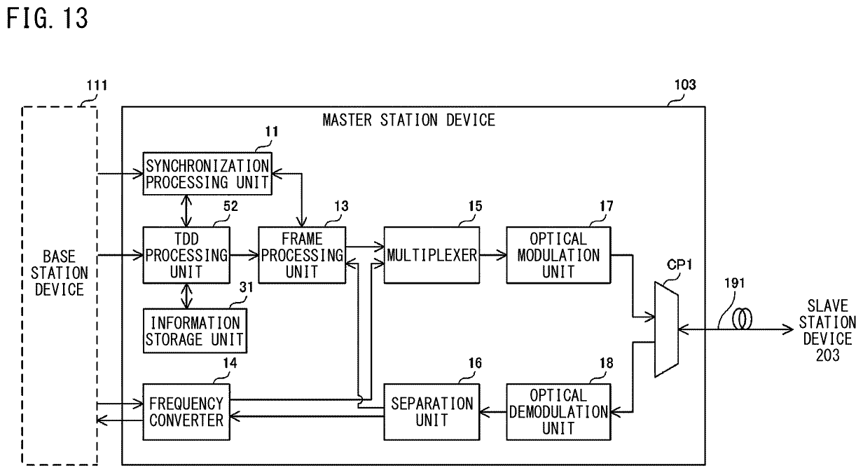

FIG. 13 shows a configuration of the master station device according to the third embodiment of the present disclosure. With reference to FIG. 13, the master station device 103 includes a TDD processing unit 52 instead of the TDD processing unit 32, as compared with the master station device 102 shown in FIG. 9.

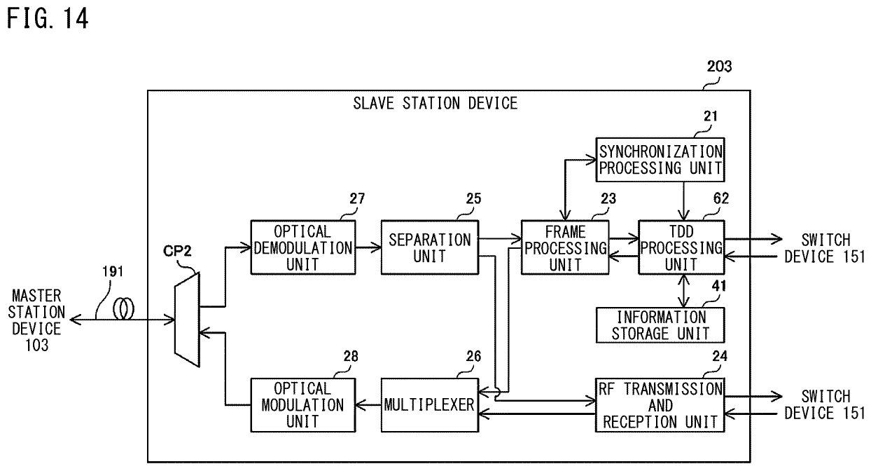

FIG. 14 shows a configuration of the slave station device according to the third embodiment of the present disclosure. With reference to FIG. 14, the slave station device 203 includes a TDD processing unit 62 instead of the TDD processing unit 42, as compared with the slave station device 202 shown in FIG. 11.

The TDD processing unit 62 receives an RF signal including pattern information from the management device 171 via the antenna 161 and the switch device 151. The TDD processing unit 62 acquires the pattern information from the received RF signal, and outputs the acquired pattern information to the frame processing unit 23.

The frame processing unit 23 receives the pattern information from the TDD processing unit 62, generates an Ethernet frame which is addressed to the master station device 103 and in which the received pattern information is stored in the payload, and outputs a digital signal Db2 including the generated Ethernet frame to the multiplexer 26. The digital signal Db2 is an example of a second digital signal. The digital signal Db2 outputted to the multiplexer 26 by the frame processing unit 23 is frequency-multiplexed with an IF signal Fb by the multiplexer 26, to be transmitted by the optical modulation unit 28 to the master station device 103 so as to be included in an uplink optical signal.

Referring back to FIG. 13, the master station device 103 acquires the pattern information from the digital signal Db2 included the uplink optical signal that has been received from the slave station device 203, and generates control information reflecting the content of the acquired pattern information.

More specifically, the frame processing unit 13 in the master station device 103 receives the digital signal Db2 from the separation unit 25, acquires the Ethernet frame from the received digital signal Db2, and acquires the pattern information from the payload of the Ethernet frame. The frame processing unit 13 outputs the acquired pattern information to the TDD processing unit 52.

The TDD processing unit 52 receives the pattern information from the frame processing unit 13, and acquires a configuration number from the received pattern information. The TDD processing unit 52 acquires, with reference to the correspondence table TB1 in the information storage unit 31, an assignment pattern PT corresponding to the acquired configuration number. The TDD processing unit 52 generates control information reflecting the acquired assignment pattern PT.

Referring back to FIG. 10, for example, in a case where the TDD processing unit 52 receives pattern information including a configuration number “C11” from the frame processing unit 13, the TDD processing unit 52 acquires an assignment pattern PT corresponding to the configuration number “C11”, and judges whether or not the acquired assignment pattern PT is in a quasi-synchronization state with respect to the TDD signal Std1 received from the base station device 111.

Specifically, in a case where the acquired assignment pattern PT corresponds to the pattern of the TDD signal Std1 in which a part of a high-level period has been changed to a low-level period, the TDD processing unit 52 judges that the acquired assignment pattern PT is in the quasi-synchronization state with respect to the TDD signal Std1, generates control information including the configuration number “C11” and a start timing ts, and outputs the generated control information to the frame processing unit 13.

Meanwhile, in a case where the TDD processing unit 52 judges that the acquired assignment pattern PT is not in the quasi-synchronization state with respect to the TDD signal Std1, the TDD processing unit 52 does not generate the control information including the configuration number “C11”.

The frame processing unit 13 receives the control information from the TDD processing unit 52, generates an Ethernet frame which is addressed to the slave station device 203 and in which the received control information is stored in the payload, and outputs a digital signal Da3 including the generated Ethernet frame to the multiplexer 15. The digital signal Da1 outputted to the multiplexer 15 by the frame processing unit 13 is frequency-multiplexed with an IF signal Fa by the multiplexer 15, to be transmitted by the optical modulation unit 17 to the slave station device 203 so as to be included in a downlink optical signal.

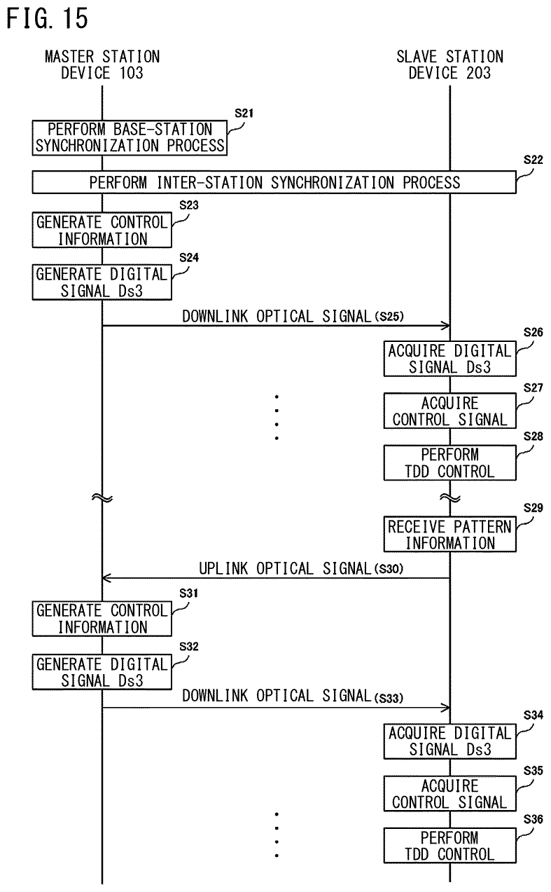

FIG. 15 shows an example of a sequence of communication in the analog RoF system according to the third embodiment of the present disclosure. With reference to FIG. 15, the master station device 103 and the slave station device 203 perform processes which are similar to the processes from step S11 to step S18 shown in FIG. 7, as the processes from step S21 to step S28.

Next, the slave station device 203 receives pattern information from the management device 171 in the mobile wireless communication system (step S29).

Next, the slave station device 203 generates an Ethernet frame which is addressed to the master station device 103 and in which the received pattern information is stored in the payload, frequency-multiplexes the digital signal Db2 including the generated Ethernet frame and an IF signal Fb, and transmits an uplink optical signal that includes the digital signal Db2 and the IF signal Fb, to the master station device 103 through the optical fiber 191 (step S30).

Next, the master station device 103 generates control information reflecting the content of the pattern information received from the slave station device 203 (step S31).

Next, the master station device 103 generates an Ethernet frame which is addressed to the slave station device 203 and in which the generated control information is stored in the payload, and generates a digital signal Da3 including the generated Ethernet frame (step S32).

Next, the master station device 103 frequency-multiplexes the digital signal Da3 and the IF signal Fa, and transmits a downlink optical signal that includes the digital signal Da3 and the IF signal Fa, to the slave station device 203 through the optical fiber 191 (step S33).

Next, the slave station device 203 receives the downlink optical signal from the master station device 103 through the optical fiber 191, and acquires the digital signal Ds3 from the received downlink optical signal (step S34).

Next, the slave station device 203 acquires the control information from the digital signal Ds3 (step S35).

Next, the slave station device 203 performs the switching process, based on the acquired control information. More specifically, the slave station device 203 generates a TDD signal Std2 based on the switching pattern included in the control information, and transmits the TDD signal Std2 to the switch device 151 at the start timing ts included in the control information (step S36).

In the analog RoF system 303 according to the third embodiment of the present disclosure, in a case where an assignment pattern PT corresponding to the configuration number included in the pattern information is in the quasi-synchronization with respect to the TDD signal Std1, the TDD processing unit 52 in the master station device 103 generates control information including the configuration number. However, the present invention is not limited thereto. The TDD processing unit 52 may generate a switching pattern including transition times tr, tf, based on the TDD signal Std1 and the assignment pattern PT corresponding to the configuration number included in the pattern information, and may generate control information including the generated switching pattern. In this case, the TDD processing unit 52 may generate a new switching pattern in which the length of the time slots S is changed.

The processes (functions) of the above-described embodiments may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network, or may be distributed in a state of being stored in a storage medium such as a CD-ROM (Compact Disc Read Only Memory), a DVD-ROM (Digital Versatile Disk Read Only Memory), or a semiconductor memory, and may be installed from the storage medium into the memory.

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional note below.

### Additional Note 1

An analog RoF system including:
a master station device; and
a slave station device configured to perform transmission and reception of a radio signal through an antenna, wherein
the master station device generates control information that is used to control a transmission operation and a reception operation of the radio signal, and transmits an optical signal that includes an analog main signal and a first digital signal including the generated control information, to the slave station device through an optical fiber,
the slave station device acquires the control information from the first digital signal included in the optical signal that has been received from the master station device through the optical fiber, and performs a switching process between the transmission operation and the reception operation of the radio signal through the antenna, based on the acquired control information, and
the master station device and the slave station device perform an inter-station synchronization process of synchronizing a count value of a local clock in the master station device and a count value of a local clock in the slave station device, at a timing according to a predetermined cycle.

### REFERENCE SIGNS LIST

11 synchronization processing unit
12, 32, 52 TDD processing unit
13 frame processing unit
14 frequency converter
15 multiplexer
16 separation unit
17 optical modulation unit
18 optical demodulation unit
21 synchronization processing unit
23 frame processing unit
24 RF transmission and reception unit
25 separation unit
26 multiplexer
27 optical demodulation unit
28 optical modulation unit
31 information storage unit
41 information storage unit
101, 102, 103 master station device
111 base station device
151 switch device
161 antenna
171 management device
191 optical fiber
201, 202, 203 slave station device
301, 302, 303 analog RoF system
CP1, CP2 optical coupler
TB1 correspondence table

1. An analog RoF (Radio over Fiber) system comprising:
a master station device; and
a slave station device configured to perform transmission and reception of a radio signal through an antenna, wherein
the master station device generates control information that is used to control a transmission operation and a reception operation of the radio signal, and transmits an optical signal that includes an analog main signal and a first digital signal including the generated control information, to the slave station device through an optical fiber, and
the slave station device acquires the control information from the first digital signal included in the optical signal that has been received from the master station device through the optical fiber, and performs a switching process between the transmission operation and the reception operation of the radio signal through the antenna, based on the acquired control information.

2. The analog RoF system according to claim 1, wherein
the master station device is connected between a base station device and the slave station device, and
the master station device receives a pattern signal indicating an uplink communication period and a downlink communication period in TDD (Time Division Duplex) from the base station device, and generates the control information, based on the received pattern signal.

3. The analog RoF system according to claim 2, wherein
the master station device generates a switching pattern for the transmission operation and the reception operation of the radio signal, based on the pattern signal, and generates the control information that includes the generated switching pattern and a start timing of the switching process using the switching pattern.

4. The analog RoF system according to claim 2, wherein
the master station device and the slave station device each retain correspondence information indicating a correspondence relationship between a type of the pattern signal and identification information of the pattern signal, and
the master station device acquires, with reference to the correspondence information, the identification information corresponding to the pattern signal that has been received from the base station device, and generates the control information that includes the acquired identification information and the start timing of the switching process using the identification information.

5. The analog RoF system according to claim 3, comprising a plurality of the slave station devices, wherein
the master station device generates the control information including the start timing different for each slave station device.

6. The analog RoF system according to claim 3, wherein
the slave station device corrects the start timing included in the control information, and starts the switching process based on the control information at the corrected start timing.

7. The analog RoF system according to claim 1, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.

8. A master station device comprising a processor programmed to perform operations comprising:
generating control information that is used to control a transmission operation and a reception operation of a radio signal through an antenna to be performed by a slave station device; and
transmitting an optical signal that includes an analog main signal and a digital signal including the generated control information, to the slave station device through an optical fiber.

9. A slave station device comprising a processor programmed to perform operations comprising:
performing transmission and reception of a radio signal through an antenna;
receiving an optical signal that includes an analog main signal and a digital signal including control information, from a master station device through an optical fiber;
acquiring the control information from the digital signal included in the received optical signal; and
performing a switching process between a transmission operation and a reception operation of the radio signal through the antenna, based on the acquired control information.

10. An optical communication method in an analog RoF system including a master station device, and a slave station device configured to perform transmission and reception of a radio signal through an antenna, the optical communication method comprising the steps of:
generating, by the master station device, control information that is used to control a transmission operation and a reception operation of the radio signal, and transmitting, by the master station device, an optical signal that includes an analog main signal and a first digital signal including the generated control information, to the slave station device through an optical fiber; and
acquiring, by the slave station device, the control information from the first digital signal included in the optical signal that has been received from the master station device through the optical fiber, and performing, by the slave station device, a switching process between the transmission operation and the reception operation of the radio signal through the antenna, based on the acquired control information.

11. The analog RoF system according to claim 4, comprising a plurality of the slave station devices, wherein
the master station device generates the control information including the start timing different for each slave station device.

12. The analog RoF system according to claim 4, wherein
the slave station device corrects the start timing included in the control information, and starts the switching process based on the control information at the corrected start timing.

13. The analog RoF system according to claim 5, wherein
the slave station device corrects the start timing included in the control information, and starts the switching process based on the control information at the corrected start timing.

14. The analog RoF system according to claim 11, wherein
the slave station device corrects the start timing included in the control information, and starts the switching process based on the control information at the corrected start timing.

15. The analog RoF system according to claim 2, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.

16. The analog RoF system according to claim 3, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.

17. The analog RoF system according to claim 4, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.

18. The analog RoF system according to claim 5, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.

19. The analog RoF system according to claim 6, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.

20. The analog RoF system according to claim 11, wherein
the slave station device receives pattern information indicating an uplink communication period and a downlink communication period in TDD from a device, other than the master station device, outside the slave station device, generates a second digital signal including the received pattern information, and transmits an optical signal that includes an analog main signal and the generated second digital signal, to the master station device through the optical fiber, and
the master station device acquires the pattern information from the second digital signal included in the optical signal that has been received from the slave station device through the optical fiber, and generates the control information reflecting content of the acquired pattern information.
